(19) United States
(12) Patent Application Publication
(10) Pub. No.: US 2025/0202315 A1
(43) Pub. Date: Jun. 19, 2025

(54) ROTOR FOR AN ELECTRIC MACHINE AND ELECTRIC MACHINE

(71) Applicant: ZF Friedrichshafen AG, Friedrichshafen (DE)

(72) Inventors: Dominik Erny, Friedrichshafen (DE); Rayk Gersten, Friedrichshafen (DE); Martin Christians, Friedrichshafen (DE); David Rittler, Neukirch (DE)

(73) Assignee: ZF Friedrichshafen AG, Friedrichshafen (DE)

(21) Appl. No.: 18/980,127

(22) Filed: Dec. 13, 2024

(30) Foreign Application Priority Data
Dec. 14, 2023 (DE) 10 2023 212 672.9

(51) Int. Cl. H02K 7/04

(52) U.S. Cl. CPC H02K 7/04

(57) ABSTRACT

A rotor for an electrical machine has a rotor arm with a radial outer dimension, a balancing disk with a radial inner dimension, and a connection arrangement having an outer contour on a side of the rotor arm and an inner contour on the side of the balancing disk. The outer contour and the inner contour correspond to one another for axial and radial support, where the connection arrangement for radial support has a first contour section with a radial connection dimension which differs from the outer dimension and the inner dimension. The rotor can have an end fin with at least one projection that extends radially inwards and/or in an axial direction to prevent twisting. The rotor can be part of an electrical machine.

### RELATED APPLICATIONS

This application claims the benefit of and right of priority under 35 U.S.C. § 119 to German Patent Application no. 10 2023 212 672.9, filed on 14 Dec. 2023, the contents of which are incorporated herein by reference in its entirety.

### FIELD OF THE DISCLOSURE

The invention relates to a rotor for an electrical machine, the rotor having a rotor arm with a radial outer dimension, a balancing disk with a radial inner dimension and a connection arrangement with an outer contour on the side of the rotor arm and an inner contour on the side of the balancing disk, wherein the outer contour and the inner contour correspond to one another for axial and radial support. Furthermore, the invention relates to an electrical machine.

### BACKGROUND

Document DE 10 2021 123 310 A1 relates to a rotor for an electrical machine, comprising a rotor shaft on which an axial stop is provided, which is formed by means of a retaining ring accommodated in a groove on the shaft side, and a rotor body that is pushed onto the rotor shaft and is axially supported on the stop. In order to be able to use the rotor at very high speeds, document DE 10 2021 123 310 A1 proposes that the locking ring be held in a recess in the rotor body and be surrounded radially by it.

### SUMMARY

The underlying objective of the invention is to improve the structure and/or function of a rotor as mentioned at the beginning. Furthermore, the invention is based on the task of improving the structure and/or function of an electrical machine as mentioned above.

The problem is solved with a rotor as provided herein. Furthermore, the task is solved using an electric machine as provided herein. Advantageous embodiments and/or further developments will be apparent from the present disclosure.

The rotor is designed as part of an electrical machine. The rotor can be designed and/or arranged to be rotatable. The rotor can be designed and/or arranged to interact with a stator. The rotor can have a rotor axis. The rotor axis can be a rotational axis and/or a longitudinal axis. Unless otherwise stated or implied, the terms “axial”, “radial” and “in the circumferential direction” refer to a direction of extension of the rotor axis. “Axial” then corresponds to a direction of extension of the rotor axis. “Radial” then refers to a direction perpendicular to the direction of extension of the rotor axis and intersecting with the rotor axis. “In the circumferential direction” then corresponds to a circular arc direction around the rotor axis. The rotor includes a rotor arm, a balancing disk and a connection arrangement.

The rotor arm can be designed as a shaft. The rotor arm has a radial outer dimension. The outer dimension can be an outer dimension that the rotor arm has over its predominant length. The outer dimension can be a nominal dimension. The outer dimension can be an outer diameter. The rotor arm can be designed to hold the balancing disk and/or a rotor body. The rotor arm can be designed to hold the balancing disk in a centered, axially defined and rotationally fixed manner. The rotor arm can be profiled radially on the outside, at least in sections.

The balancing disk is designed and/or arranged to balance the rotor. The balancing disk can have at least one balancing recess and/or at least one balancing weight. The balancing disk can be asymmetrical. The balancing disk can have an asymmetrical shape in relation to a center plane perpendicular to the rotor axis. The balancing disk has a radial inner dimension. The inner dimension can be the same as the outer dimension of the rotor arm, or at least approximately correspond to the outer dimension of the rotor arm. The inner dimension can be a nominal dimension. The inner dimension can be an inner diameter. The balancing disk can be designed for mounting on the rotor arm. The balancing disk can be designed for centered, axially defined and torsionally rigid mounting on the rotor arm. The balancing disk can be at least essentially free of longitudinal profiles on the radial inner side. The balancing disk may have an axial dimension. The axial dimension can also be referred to as the thickness or width.

The connection arrangement can be designed to connect the balancing disk and the rotor arm. The connection arrangement can be designed to connect the balancing disk and the rotor arm in a centered, axially defined and rotationally fixed manner. The connection arrangement has an outer contour on the side of the rotor arm and an inner contour on the side of the balancing disk. The outer contour and the inner contour correspond to each other for axial and radial support. The support can be designed and/or arranged to directly support the balancing disk on the rotor arm. The support can be designed and/or arranged to indirectly support the balancing disk on the rotor arm, for example with the help of a support ring and/or a support groove. The connection arrangement can extend over an axial region. The axial region can correspond to one axial dimension of the balancing disk. The axial region can extend between a first axial end and a second axial end.

The rotor may have a rotor body. The rotor body may have plates or fins. The plates or fins may be packaged. The rotor body may have a radial inner dimension. The inner dimension can be the same as the outer dimension of the rotor arm, or at least approximately correspond to the outer dimension of the rotor arm. The inner dimension can be a nominal dimension. The inner dimension can be an inner diameter. The rotor body can be designed for mounting on the rotor arm. The rotor body can be designed for centered, axially defined and rotationally fixed mounting on the rotor arm. The rotor body can be profiled radially on the inside.

The connection arrangement has a first contour section for radial support. The first contour section can have a first contour section on the side of the rotor arm and a first contour section on the side of the balancing disk. The first contour section has a radial connection dimension that differs from the outer and inner dimensions. The first contour section can show a connection dimension that is larger than the outer and inner dimensions. The connection dimension on the side of the rotor arm can be an outer dimension or an inner diameter. The connection dimension on the side of the balancing disk can be an inner dimension or an inner diameter. The first contour section can extend in the axial direction. The first contour section can extend over an axial sub-region. The axial sub-region can be a sub-region of the axial region over which the connection arrangement extends.

The connection arrangement may be an interference fit on the first contour section. The interference fit may be designed in such a way that a predetermined minimum pressure is ensured even at maximum rotor speed, in particular in the case of a centrifugal force acting at maximum rotor speed.

The connection arrangement can have an inside and an outside. The inner side can face the rotor body axially. The outer side can be axially turned away from the rotor body. The first contour section can be arranged on the outside. The first contour section can be arranged axially on the outside.

The connection arrangement can have a second contour section for axial support. The second contour section can have a second contour section on the side of the rotor arm and a second contour section on the side of the balancing disk. The second contour section can extend in the radial direction. The second contour section can be arranged centrally on the axial region. The second contour section can be arranged between a first end and a second end of the axial region. The second contour section can be arranged at least approximately in the center between a first end and a second end of the axial region. The second contour section can be contoured like a pivot bearing. The second contour section can have a minimized support surface. The second contour section can be designed and/or arranged to provide at least an approximately linear support. The second contour section can have a ring-shaped supporting section.

The connection arrangement can have a third contour section that complements the axial region. The third contour section can have a third contour section on the side of the rotor arm and a third contour section on the side of the balancing disk. The third contour section can have a radial dimension that at least approximately corresponds to the outer and inner dimensions. The radial dimension can be an outer dimension or an outer diameter on the side of the rotor arm. The radial dimension can be an inner dimension or an inner diameter on the side of the balancing disk. The third contour section can extend in the axial direction. The third contour section can extend over an axial sub-region. The axial sub-region can be a sub-region of the axial region over which the connection arrangement extends. The axial region can be added to and/or completed with the third contour section. The first contour section and the third contour section can completely fill the axial region.

The connection arrangement may be optional on the third contour section. The connection arrangement can be radially offset on the third contour section. The third contour section on the side of the rotor arm and the third contour section on the side of the balancing disk can be radially spaced apart. A radial gap can be kept free between the third contour section on the side of the rotor arm and the third contour section on the side of the balancing disk. The third contour section on the side of the balancing disk can be axially released. The third contour section on the side of the balancing disk can be axially relieved on its side facing the first contour section and/or the second contour section. The third contour section on the side of the balancing disk can be left blank in the manner of a recess.

The connection arrangement can have an anti-twist device. The anti-twist device can be arranged in an axial sub-region. The anti-twist element can be arranged in an axial sub-region assigned to the third contour section. An axial sub-region can be held without any anti-twist lock. An axial sub-region assigned to the first contour section can be held without an anti-twist device.

The anti-twist device can have at least one projection on the side of the balancing disk. The anti-twist device can have at least one recess on the side of the rotor arm. The at least one recess on the side of the rotor arm can be formed with the help of a groove in the rotor arm. The at least one projection can extend radially inwards. The at least one projection can be held in the at least one recess on the side of the rotor arm in a force-fitting and/or form-fitting manner in the circumferential direction. The anti-twist device can have at least one recess on the side of the balancing disk. The anti-twist device can have at least one projection on the side of the rotor arm.

The rotor, in particular the rotor body, can have at least one fin, in particular an end fin. The at least one projection on the side of the rotor arm can be formed with the aid of the at least one fin, in particular the end fin. The anti-twist device can be present on at least one fin, in particular the end fin, or can be formed with the help of at least one fin, in particular the end fin. At least one fin, in particular the end fin, can have at least one projection. The at least one projection can extend radially inwards and/or in an axial direction. The at least one projection can be held in the at least one recess on the side of the rotor arm and/or in the at least one recess on the side of the balancing disk in a force-fitting and/or form-fitting manner in the circumferential direction. At least one projection of at least one fin, in particular of the end fin, can be designed as a tab bent over in an axial direction.

The balancing disk can have at least one recess that forms a fluid channel. The at least one recess can be designed and/or arranged to reduce or prevent a build-up of coolant and/or lubricant in a rotor body.

The electric machine can be designed and/or arranged to operate as a motor and/or generator. The electric motor can be designed for use in a motor vehicle and/or can be arranged. The electric motor has the rotor. The electric machine may have a stator. The electric machine may have a housing. The stator can be fixed to the housing. The rotor can be rotatably mounted on the housing.

The invention improves balancing quality. Deformation and/or displacement of the balancing disk, in particular under the effect of the centrifugal force caused by the speed and/or speed gradient, is reduced or prevented.

### BRIEF DESCRIPTION OF THE DRAWINGS

In the following, exemplary embodiments of the invention are described in more detail with reference to figures, showing schematically and by way of example:

FIG. 1: a rotor of an electrical machine with a rotor arm and a balancing disk in sectional view

FIG. 2: a sectional view of a connection arrangement between a rotor arm and a balancing disk of a rotor.

FIG. 3: a sectional view of a connection arrangement between a rotor arm and a balancing disk of a rotor.

FIG. 4: a connection arrangement between a rotor arm and a balancing disk of a rotor in a sectional view,

FIG. 5: a connection arrangement effective between a rotor arm and a balancing disk of a rotor in a sectional detail view and

FIG. 6: shows a cross-section of one end fin of a rotor with bent-over tabs to prevent twisting.

### DETAILED DESCRIPTION

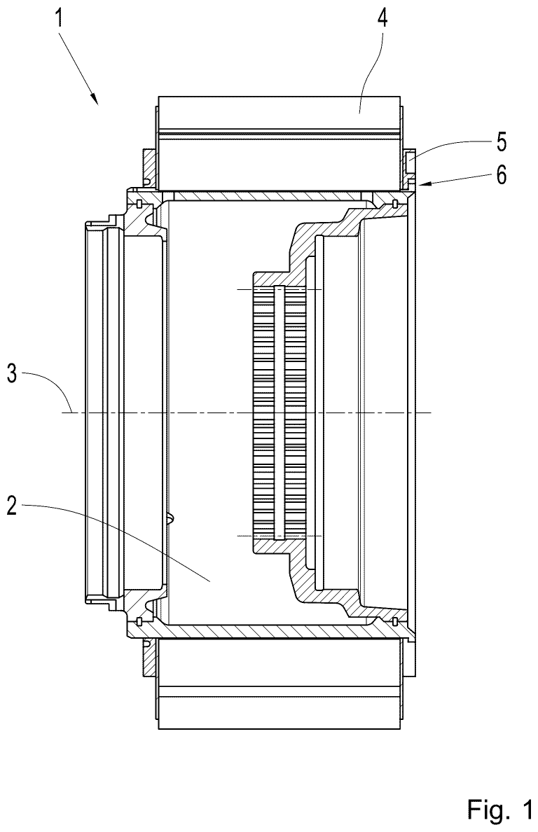

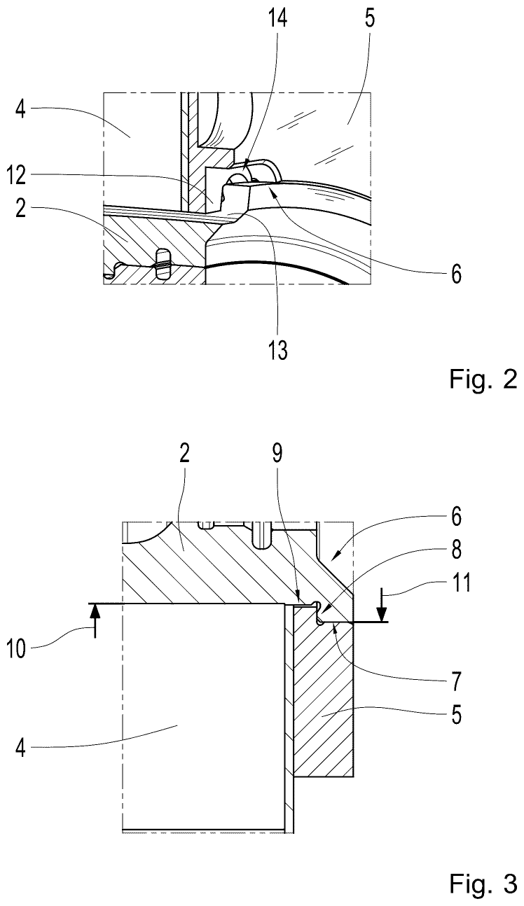

FIG. 1 shows a rotor 1 of an electrical machine with a rotor arm 2, a rotor axle 3, a rotor body 4, a balancing disk 5 and a connection arrangement 6 for the centered, axially defined and rotationally fixed connection of the balancing disk 5 to the rotor arm 2. FIGS. 2 and 3 show a partial detail of connection arrangement 6.

The connection arrangement 6 has a first contour section 7, a second contour section 8 and a third contour section 9. The first contour section 7 is used for radial support and has a larger connection dimension 11 and an interference fit compared to an outer dimension 10 of the rotor arm 2. The second contour section 8 serves as axial support and has a minimized support surface for pivot-bearing-type support. A radial gap is kept free at the third contour section 9. This allows or assists in the deformation of the balancing disk 5 under the effect of the speed-related centrifugal force with its circumference in the direction of the rotor body 4 and counteracts the formation of a gap between the balancing disk 5 and the rotor body 4.

The balancing disk 5 has a radially inward projection 12, which is held in a groove 13 of the rotor arm 2 in a form-fitting and optionally force-fitting manner to prevent twisting. In addition, the balancing disk 5 has a recess 14 that forms a fluid channel to reduce or prevent coolant and/or lubricant buildup in the rotor body 4.

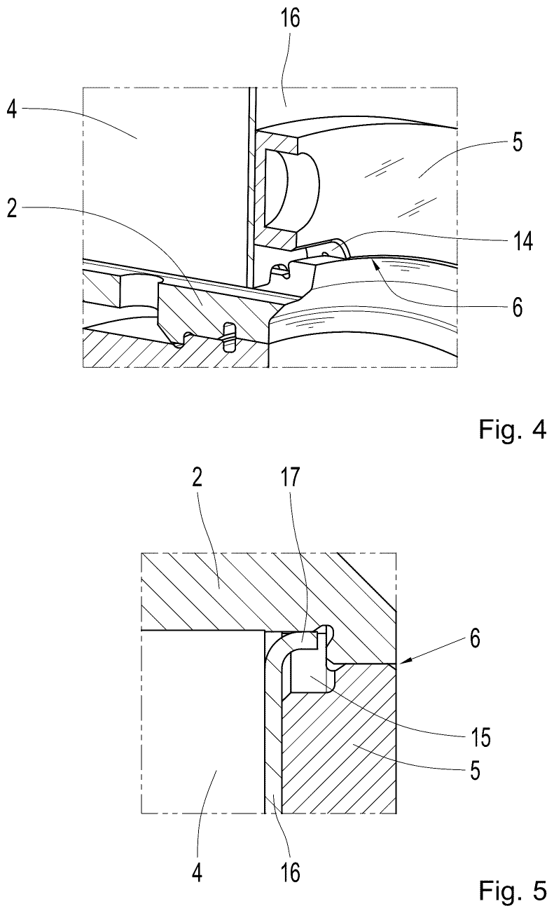

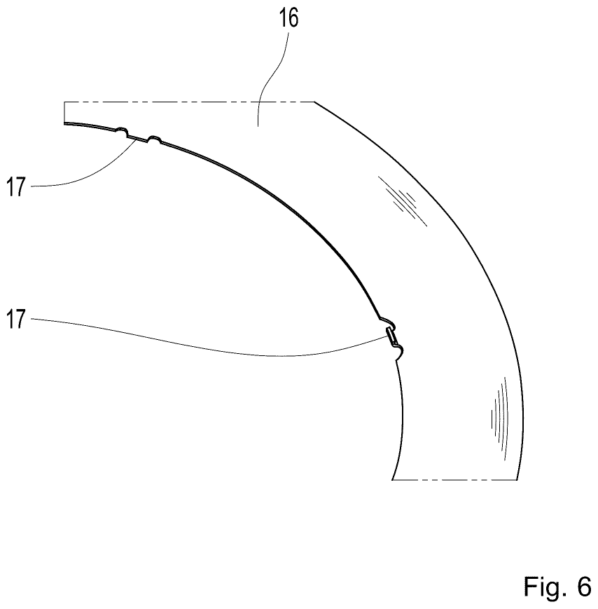

FIG. 4 and FIG. 5 show an embodiment of the connection arrangement 6, in which, for the purpose of protection against twisting, the balancing disk 5 has recesses, such as recess 15, and an end fin 16 bas and projections 17 that are designed as bent-over tabs and project into the recesses 15, on which the balancing disk 5 is supported in the peripheral direction in a non-positive and positive manner. The end fin 16 also engages with a projection 17 in the groove 13 of the rotor arm 2. FIG. 6 shows the end fin 16 with the bent-over tabs 17. For further details, please also refer to FIG. 1, FIG. 2 and FIG. 3 and the corresponding description.

### LIST OF REFERENCE NUMERALS

1 rotor
2 rotor arm
3 rotor axis
4 rotor bodies
5 balancing disk
6 connection arrangement
7 first contour section
8 second contour section
9 third contour section
10 outer dimension
11 connection dimension
12 projection
13 groove
14 recess
15 recess
16 end fin
17 tab

1. A rotor (1) for an electrical machine, comprising:
a rotor arm (2) with a radial outer dimension (10);
a balancing disk (5) with a radial inner dimension; and
a connection arrangement (6) with an outer contour on a side of the rotor arm and an inner contour on a side of the balancing disk;
wherein the outer contour and the inner contour correspond to one another for axial and radial support; and
wherein the connection arrangement (6) for radial support has a first contour section (7) with a radial connection dimension (11) deviating from the outer dimension (10) and the inner dimension.

2. The rotor (1) according to claim 1, wherein the connection arrangement (6) has an interference fit on the first contour section (7)

3. The rotor (1) according to claim 2, wherein the interference fit is configured to guarantee a predetermined minimum pressure.

4. The rotor (1) according to claim 1, wherein the connection arrangement (6) extends over an axial region corresponding to an axial dimension of the balancing disk (5) and the first contour section (7) extends over an axial sub-region.

5. The rotor (1) according to claim 1, wherein the connection arrangement (6) has an inner side axially facing a rotor body (4) and an outer side axially facing away from the rotor body (4), and the first contour section (7) is arranged on the outside.

6. The rotor (1) according to claim 1, wherein the connection arrangement (6) extends over an axial region corresponding to an axial dimension of the balancing disk (5), the connection arrangement (6) bas a second contour section (8) for axial support, and the second contour section (8) is arranged centrally on the axial region.

7. The rotor (1) according to claim 6, characterized in that the second contour section (8) is contoured in the manner of a pivot bearing.

8. The rotor (1) according to claim 1, wherein the connection arrangement (6) extends over an axial region corresponding to an axial dimension of the balancing disk (5), the connection arrangement (6) bas a third contour section (9) supplementing the axial region, and the connection arrangement (6) is left free at the third contour section (9).

9. The rotor (1) according to claim 8, wherein the connection arrangement (6) has an anti-twist device in an axial sub-region associated with the third contour section (9).

10. The rotor (1) according to claim 9, wherein the anti-twist device has at least one projection (12) on the side of the balancing disk and/or at least one recess (15) on the side of the balancing disk.

11. The rotor (1) according to claim 9, wherein the rotor (1) has at least one fin and the anti-twist device has the at least one fin.

12. The rotor (1) according to claim 11, wherein the at least one fin is configured as an end fin (16) having at least one projection (17) which extends radially inwards and/or in an axial direction.

13. The rotor (1) according to claim 1, wherein the balancing disk (5) has at least one recess (14) defining a fluid channel.

14. An electric machine, comprising the rotor (1) according to claim 1.
